(19) United States
(12) Patent Application Publication
(10) Pub. No.: US 2017/0053281 A1
(43) Pub. Date: Feb. 23, 2017

(54) Card Continuity System and Method

(71) Applicant: MasterCard International Incorporated, Purchase, NY (US)

(72) Inventors: Justin Howe, San Francisco, CA (US); Todd Lowenberg, Redding, CT (US); Andrew Reiskind, Armonk, NY (US); Randy Shuken, Westport, CT (US); Curtis Villars, Chatham, NJ (US)

(21) Appl. No.: 14/831,756

(22) Filed: Aug. 20, 2015

(51) Int. Cl. G06Q 20/40; G06Q 20/38; G06Q 20/10

(52) U.S. Cl. CPC G06Q 20/4014; G06Q 20/108; G06Q 20/3821

(57) ABSTRACT

A system, method, and computer-readable storage medium configured to maintain account continuity when payment account numbers change.

### BACKGROUND

Field of the Disclosure

Aspects of the disclosure relate in general to financial services. Aspects include a method and system to maintain account continuity when payment account numbers change.

Description of the Related Art

A payment card is a card that can be used by a cardholder and accepted by a merchant to make a payment for a purchase or in payment of some other obligation. Payment cards include credit cards, debit cards, charge cards, and Automated Teller Machine (ATM) cards. Payment cards provide the clients of a financial institution (“cardholders”) with the ability to pay for goods and services without the inconvenience of using cash.

Payment cards offer cardholders any easy way to pay periodic bills, by choosing an “auto pay” feature, where vendors periodically bill the cardholder's payment card account.

The payment industry suffers from problems related to fraud. High fraud rates make it risky for the card issuing financial institution (“issuers”) to approve transactions perceived to be risky, especially when a payment card account is compromised. As a result, issuers often attempt to mitigate the risk by canceling payment card accounts, and reissuing the cardholder a new payment card account.

Generally, at least one payment network currently provides fraud scoring for payment card transactions. Fraud scoring refers to an indication, or likelihood, that a payment transaction is fraudulent. In one fraud scoring system, the payment card network provides a number back to the payment card issuer between zero and 1,000, which translates into zero and 100 percent, in tenths of percentage points. To provide fraud-scoring capability, various vendors or payment card companies provide and market various different fraud scoring products. A payment card company generally selects one of the vendor products to provide its customers (the card issuers) with one of fraud scoring and credit risk scoring that is accessible, for example, on a payment card network.

### SUMMARY

Embodiments include a system, device, method and computer-readable medium to maintain account continuity when payment account numbers change.

In a first method, the method comprises receiving, via a network interface, transaction data from a merchant bank. The transaction data includes a Primary Account Number (PAN). A processor matches a customer account in a database with the Primary Account Number. The processor extracts personally identifiable information (PII) from the transaction data. The processor hashes the personally identifiable information resulting in hashed personally identifiable information. The hashed personally identifiable information is stored with the customer account in the database.

In another method of maintaining payment account continuity, the method comprises receiving, via a network interface, a transaction authorization request for a financial transaction from a merchant bank. The transaction authorization request includes a Primary Account Number (PAN). A processor matches a first customer account in a database with the Primary Account Number. When the first customer account does not have an associated first spending profile, the processor extracts personally identifiable information (PII) from the transaction data, hashes the personally identifiable information resulting in hashed personally identifiable information, and matches a second customer account in a database with the hashed personally identifiable information. The second customer account is associated with a second spending profile. The processor scores the financial transaction with the second spending profile, resulting in a transaction score. The network interface transmits the transaction score to an issuer of the Primary Account Number. In payment network embodiments that perform acquirer-side processing, the transaction score may be provided to acquirers or electronic commerce merchants.

In yet another method of maintaining payment account continuity, the method comprises receiving, via a network interface, a transaction authorization request for a financial transaction from a merchant bank. The transaction authorization request includes a Primary Account Number (PAN) of a cancelled customer account. A processor extracts personally identifiable information (PII) from the transaction data, and hashes the personally identifiable information resulting in hashed personally identifiable information. The processor matches an active customer account in a database with the hashed personally identifiable information. The active customer account is associated with an active spending profile. The processor scores the financial transaction with the active spending profile, resulting in a transaction score. The network interface transmits the transaction score to an issuer of the active customer account.

### BRIEF DESCRIPTION OF THE DRAWINGS

FIG. 1 is a block diagram illustrating a payment system to maintain account continuity when payment account numbers change.

FIG. 2 is a block diagram of a payment network configured to maintain account continuity when payment accounts change.

FIG. 3 illustrates a process to extract and hash personally identifiable information (PII) to maintain account continuity when payment card account numbers change.

FIG. 4 depicts a method of using a pre-existing fraud analysis profile for an account to maintain continuity when payment card account numbers change.

FIG. 5 illustrates a method of processing a payment transaction for a cancelled account to maintain continuity when payment card account numbers change.

### DETAILED DESCRIPTION

One aspect of the disclosure includes the realization that while changing payment card account numbers may minimize the issuer's fraud exposure, it can inconvenience the cardholder, may deprive the merchant of a sale, and may deprive the issuer of incremental revenue on a purchase.

Another aspect of the disclosure includes the realization that changing payment card account numbers prevents the reuse of existing (anti-fraud) spending profiles for an account, as such spending profiles are tied to account numbers, and not individuals. When a new account number is created, a new spending profile is created independent of the existing spending profile, resulting in unnecessary fraud exposure.

A further aspect of the disclosure is the realization that a method of maintaining continuity between account numbers by using Personally Identifiable Information (PII). Personally Identifiable Information may be any information about an individual that can be used to distinguish or trace an individual's identity, such as name, government identification number (e.g. social security number, driver's license number), date and place of birth, mother's maiden name, or biometric records that can uniquely identify the accountholder. Furthermore, PII may further include:
Magnetic Stripe Name—Full Name or Broken into First Name and Surname
Address Verification System (AVS) Requests—Postal Code Only
AVS Requests—Full Address
AVS Requests—Numeric Address
Frequent Flier Number
Loyalty Number
Airline Ticket Passenger Name

There is great variability in receiving the types of PII received; while such PII information is not a requirement to process a transaction, the information is provided on a voluntary basis to help counter fraud. The following embodiments describe a method and system to maintain account continuity when payment account numbers change, maintaining continuity in a spending profile and periodic billing context. While embodiments described herein are applied to these contexts, it is understood by those familiar with the art that the concepts, apparatus, system and methods described herein may also be applicable to any context in which maintaining account continuity is helpful. Other contexts include maintaining accurate issuer reporting in the number of accounts, in determining account attrition/churn, more accurate modeling of account level spend behavior and rare purchases, and automated recognition of accountholder address changes.

The systems and processes are not limited to the specific embodiments described herein. In addition, components of each system and each process can be practiced independently and separately from other components and processes described herein. Each component and process also can be used in combination with other assembly packages and processes.

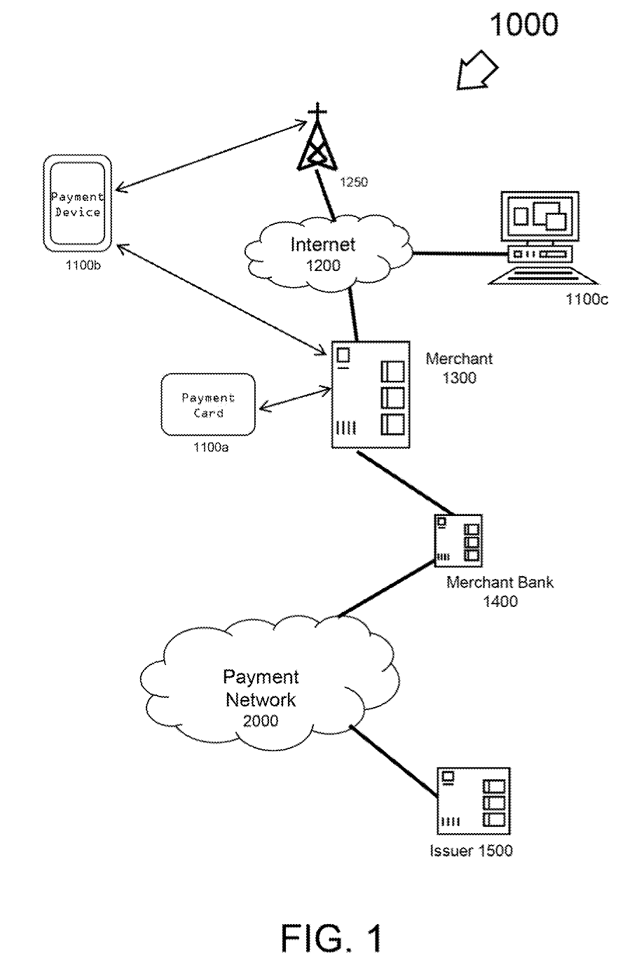

FIG. 1 is a block diagram 1000 illustrating a payment system configured to maintain account continuity when payment account numbers change. The present disclosure is related to a payment system, such as a credit card payment system using a payment network 2000, such as the MasterCard® interchange, Cirrus® network, or Maestro®. The MasterCard interchange is a proprietary communications standard promulgated by MasterCard International Incorporated of Purchase, N.Y., for the exchange of financial transaction data between financial institutions that are customers of MasterCard International Incorporated. Cirrus is a worldwide interbank network operated by MasterCard International Incorporated linking debit and payment devices to a network of ATMs throughout the world. Maestro is a multi-national debit card service owned by MasterCard International Incorporated.

In a financial payment system, a financial institution called the “issuer” 1500 issues a payment device to a consumer, who uses payment device 1100a-c to tender payment for a purchase from a merchant 1300. Payment devices may include a payment card 1100a, payment device 1100b (such as key fobs, mobile phones, tablet computers, Personal Digital Assistants (PDAs), electronic wallets and the like), or computers 1100c. Payment devices may be used to tender purchase in-person at merchant 1300, or when connected via a mobile telephone network 1250 or the internet 1200.

In this example, a user presents the payment device 1100b to a point-of-sale device at merchant 1300. The merchant is affiliated with a financial institution. This financial institution is usually called the merchant bank 1400, the “acquiring bank,” “acquirer bank,” or “acquirer.” When a payment device 1100b is tendered at merchant 1300, the merchant 1300 electronically requests authorization from the merchant bank 1400 for the amount of the purchase. The request is performed electronically with the consumer's account information. In payment cards, the consumer's account information may be retrieved from the magnetic stripe on a payment card 1100a or via a computer chip imbedded within the payment card 1100a. For other types of payment devices 1100b, the consumer's account information may be retrieved by wireless methods, such as contactless communication like MasterPass® or via Near Field Communication (NFC). The account information is forwarded to transaction processing computers of the merchant bank 1400. Alternatively, a merchant bank 1400 may authorize a third party to perform transaction processing on its behalf. In this case, the merchant 1300 will be configured to communicate with the third party. Such a third party is usually called a “merchant processor” or an “acquiring processor” (not shown).

The computers of the merchant bank 1400 or the merchant processor will communicate, via payment network 2000, with the computers of the issuer 1500 to determine whether the consumer's account is in good standing and whether the cross-border transaction is likely to be fraudulent. In part, the issuer 1500 make this determination based on the fraud scoring by payment network 2000. When a transaction occurs, payment network 2000 uses existing (anti-fraud) spending profiles associated with an account number. Typically, when a transaction occurs with a new account number payment network 2000 initially uses a generic spending profile, as no existing spending profile exists for the account; doing so unnecessarily exposes the transaction to potential fraud. However, embodiments of the present disclosure are able to use the pre-existing spending profile of the account holder in the present transaction, reducing the potential for fraud.

It is understood that any number of issuers 1500a-n may be connected to payment network 2000.

When a request for authorization is accepted, the available balance of accountholder's account is decreased.

Whenever an issuer 1500 reassigns an accountholder a new account number, it cancels the old payment account number and issues a new payment account number. Typically, the payment network 2000 is unaware of an accountholder is being given a new account number. Consequently, payment network 2000 cannot differentiate between new accountholders and existing accountholders that are changing account numbers. Embodiments as of the present disclosure allow payment network 2000 to make that differentiation.

After a transaction is captured, a clearing process occurs in which transactions are batched processed by payment network 2000, merchant 1300, merchant bank 1400, and issuer 1500. During the clearing process, merchant 1300 may attach addenda information to the transaction information. The addenda information may contain personally identifiable information, which embodiments can use to maintain account continuity when payment account number changes.

Eventually, the transaction is settled between the merchant 1300, the merchant bank 1400, and the issuer 1500.

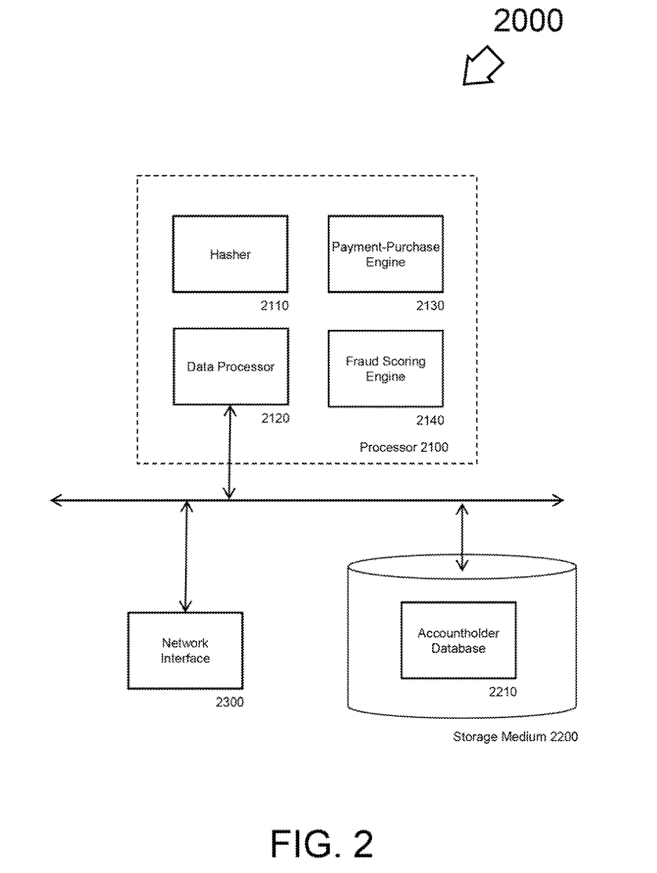

Embodiments will now be disclosed with reference to a block diagram of an exemplary payment network server 2000 of FIG. 2, configured to maintain account continuity when payment account numbers change, constructed and operative in accordance with an embodiment of the present disclosure.

Payment network server 2000 may run a multi-tasking operating system (OS) and include at least one processor or central processing unit (CPU) 2100, a non-transitory computer-readable storage medium 2200, and a network interface 2300.

Processor 2100 may be any central processing unit, microprocessor, micro-controller, computational device or circuit known in the art. It is understood that processor 2100 may temporarily store data and instructions in a Random Access Memory (RAM) (not shown), as is known in the art.

As shown in FIG. 2, processor 2100 is functionally comprised of a fraud scoring engine 2140, a payment-purchase engine 2130, a data processor 2120 and a hasher 2110.

Data processor 2120 interfaces with storage medium 2200 and network interface 2300. The data processor 2120 enables processor 2100 to locate data on, read data from, and writes data to, these components.

Payment-purchase engine 2130 performs payment and purchase transactions, and may do so in conjunction with fraud scoring engine 2140.

Fraud scoring engine 2140 is the structure that enables anti-fraud scoring or rules-based fraud of a financial transaction. Fraud scoring engine 2140 may store data related to accountholder payment credit, debit, or charge information in an accountholder database 2210. Additionally, accountholder database 2210 they store hashed personally identifiable information and spending (fraud) profiles.

These structures may be implemented as hardware, firmware, or software encoded on a computer readable medium, such as storage medium 2200. Further details of these components are described with their relation to method embodiments below.

Computer-readable storage medium 2200 may be a conventional read/write memory such as a magnetic disk drive, floppy disk drive, optical drive, compact-disk read-only-memory (CD-ROM) drive, digital versatile disk (DVD) drive, high definition digital versatile disk (HD-DVD) drive, Blu-ray disc drive, magneto-optical drive, optical drive, flash memory, memory stick, transistor-based memory, magnetic tape or other computer-readable memory device as is known in the art for storing and retrieving data. In some embodiments, computer-readable storage medium 2200 may be remotely located from processor 2100, and be connected to processor 2100 via a network such as a local area network (LAN), a wide area network (WAN), or the Internet.

In addition, as shown in FIG. 2, storage medium 2200 contain an accountholder database 2210.

Network interface 2300 may be any data port as is known in the art for interfacing, communicating or transferring data across a computer network, examples of such networks include Transmission Control Protocol/Internet Protocol (TCP/IP), Ethernet, Fiber Distributed Data Interface (FDDI), token bus, or token ring networks. Network interface 2300 allows payment network server 2000 to communicate with merchant 1300 and issuer 1500.

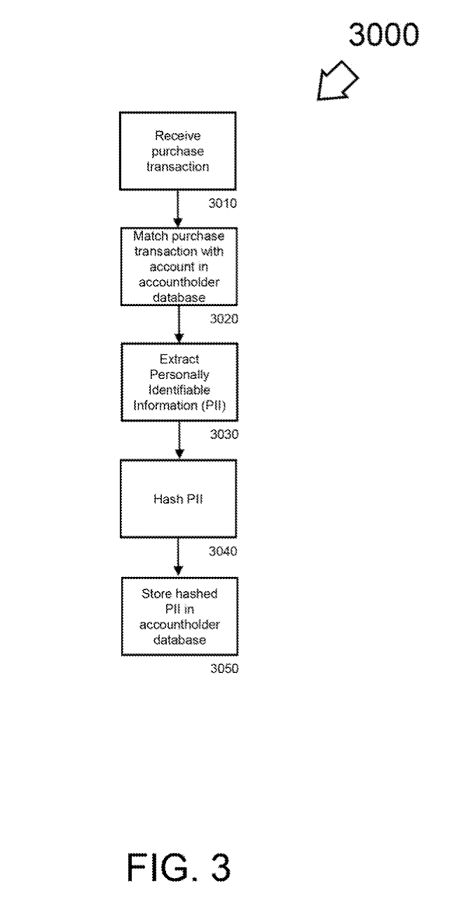

We now turn our attention to method or process embodiments of the present disclosure, FIGS. 3-5. It is understood by those known in the art that instructions for such method embodiments may be stored on their respective computer-readable memory and executed by their respective processors. It is understood by those skilled in the art that other equivalent implementations can exist without departing from the spirit or claims of the invention.

FIG. 3 illustrates a process 3000 to extract and hash personally identifiable information (PII) to maintain account continuity when payment card account numbers change, constructed and operative in accordance with an embodiment of the present disclosure. It is understood by those familiar with the art that process 3000 may be a non-real time clearing process, but in alternate embodiments may be a real time process. Conventionally, a clearing process is a non-real time process; an authentication process is a real time process.

Process 3000 collects and hashes PII, which results in data that can be used to identify payment accounts with the same accountholder during future transactions or other instances in which account continuity is useful.

Payment network 2000 receives transaction data from a merchant bank, block 3010. The transaction data is received electronically via a network interface, and may be part of data from many transactions received via an authentication, clearing or settlement process. The transaction data includes a Primary Account Number or other payment account identifier, and may include personally identifiable information, such as an accountholder name. For example, in an authentication transaction of a payment card, the personally identifiable information may include information from the payment card magnetic stripe, such as name and address. Additionally when process 3000 is a clearing process, the transaction data may include addenda data, which may also include personally identifiable information such as name, address, and government identification number. There is great variability in receiving the addenda received; while such addenda information is not a requirement to process a transaction, the information is provided on a voluntary basis to help counter fraud.

At block 3020, the transaction is matched with an account in the accountholder database 2210. This matching may occur using the Primary Account Number or other payment account identifier.

All personally identifiable information is extracted from the transaction data by processor 2100 at block 3030. The extracted information may be any PII as described above.

The PII is hashed by hasher 2110, block 3040, resulting in hashed PII. A hash is any function that can be used to map digital data of arbitrary size to digital data of fixed size, with slight differences in input data producing very big differences in output data. The values returned by a hash function are called “hash values,” “hash codes,” “hash sums,” or simply “hashes.” Example hashes include, but are not limited cryptographic hash functions, such as MD2 Message-Digest Algorithm (MD2), RACE Integrity Primitives Evaluation Message Digest (RIPEMD) hash algorithm, Secure Hash Algorithm (SHA), a Merkle-Damgård hash function, or any other hash algorithm known in the art.

In some embodiments, a truncated portion of the PAN may be appended for or pre-pended to a piece of PII and then hashed. BIN6, BIN9 or any pre-determined truncated portion of the PAN may be used. A BIN6 is the first six numbers of a Primary Account Number, and signify the issuer and portfolio of the payment account. BIN9 is the first nine numbers of a Primary Account Number. In an embodiment that uses BIN6, the BIN6 of a card may be appended or pre-pended to a piece of PII and then hashed, so that the result can only be used to link different card numbers within the same BIN (as is often the case with post-compromise reissuance, or scheduled reissuance due to payment card expiration). For example, suppose that the PII retrieved is the name of the accountholder, “John Smith.” In one embodiment, the BIN6 is appended or pre-pended to “John Smith” and then hashed.

The hashed PII is stored in the accountholder database 2210, block 3050.

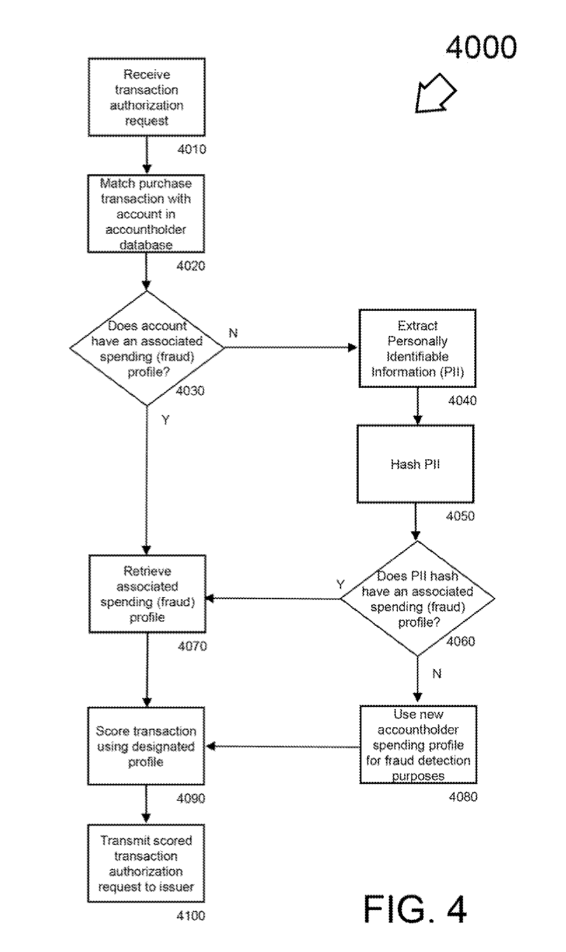

FIG. 4 illustrates a real-time method 4000 of using a pre-existing fraud analysis profile for an account to maintain continuity when payment card account numbers change, constructed and operative in accordance with an embodiment of the present disclosure.

Payment network 2000 receives transaction authorization request from a merchant 1300 with the network interface 2300, block 4010. The transaction authorization request typically contains information such as the amount of the transaction and a Primary Account Number associated with the payment device, and the (location) origin of the transaction.

The transaction authorization request is matched with an account in the accountholder database 2210 with the processor 2100, block 4020. The matching may occur using the Primary Account Number or other payment account identifier.

At decision block 4030, processor 2100 determines whether the account has an associated spending (fraud) profile. If a profile exists, the process flow continues at block 4070. If a profile does not exist, process 4000 attempts to match hashed personally identifiable information to locate a spending profile associated with another account belonging to the accountholder, and the process continues at block 4040.

All personally identifiable information is extracted from the transaction data by processor 2100 at block 4040. The extracted information may be any PII as described above.

The PII is hashed by hasher 2110, block 4050, resulting in hashed PII. As discussed above, in some embodiments, a truncated portion of a card PAN may be appended or pre-pended to a piece of PII and then hashed, so that the result can only be used to link different card numbers within the same BIN.

At decision block 4060, processor 2100 attempts to match the hashed PII with a pre-existing spending profile. This alternate spending profile may be related to an account that is still active or has been canceled. If the hashed PII with a pre-existing spending profile exists, the process continues at block 4070. If not, a new accountholder spending profile is used for fraud detection purposes, at block 4080, and the process continues at block 4090.

At block 4070, the associated spending profile is retrieved with the processor 2100.

At block 4090, the payment transaction is scored by the fraud scoring engine 2140 using the designated spending profile.

The scored transaction authorization request is transmitted to the issuer 1500 with network interface 2300, block 4100. In payment network embodiments that perform acquirer-side processing, the transaction score may be transmitted to a merchant bank 1400 or merchants 1300.

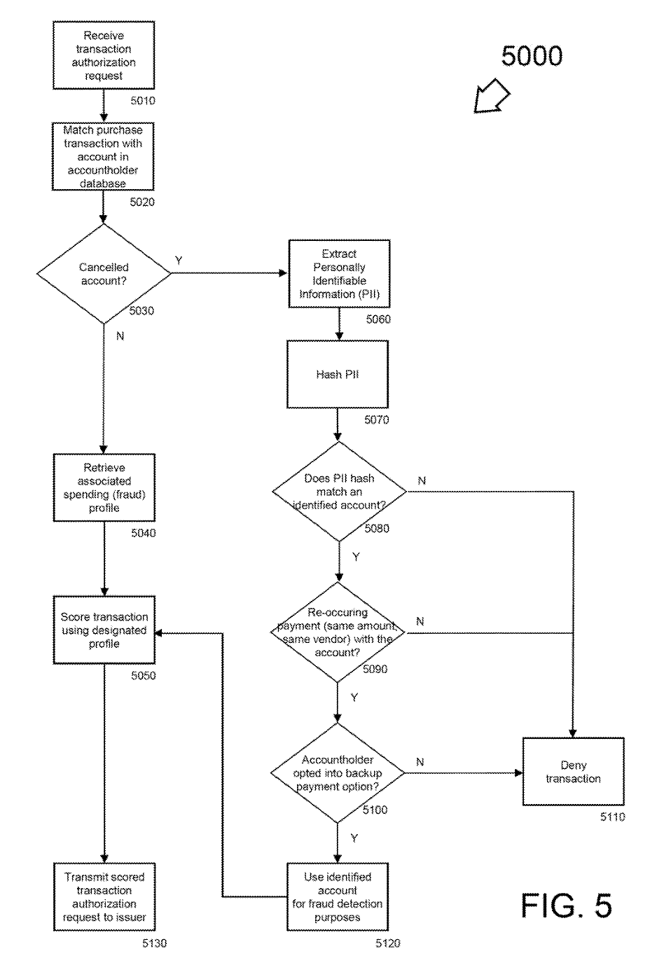

FIG. 5 illustrates a method 5000 of processing a payment transaction for a cancelled account to maintain continuity when payment card account numbers change, constructed and operative in accordance with an embodiment of the present disclosure. In this method embodiment, accountholders may opt in to an option that allows their periodic bills to be automatically paid by a payment account, even when the payment account number is cancelled and replaced by a new payment account number. Some embodiments may require that the accountholder specify the vendor and amount during the opt in process. Other embodiments may examine the periodic nature of the payment, and automatically allow other periodic payments.

Payment network 2000 receives transaction authorization request from a merchant 1300 with the network interface 2300, block 5010. The transaction authorization request typically contains information such as the amount of the transaction and a Primary Account Number associated with the payment device, and the (location) origin of the transaction.

The transaction authorization request is matched with an account in the accountholder database 2210 with the processor 2100, block 5020. The matching may occur using the Primary Account Number or other payment account identifier.

At decision block 5030, processor 2100 determines whether the account is cancelled. If the account has not been cancelled, the associated spending (fraud) profile is retrieved, block 5040, and the process flow continues at block 5050.

When the account being billed is a cancelled account, as determined at decision block 5030, process 5000 attempts to find another account to bill, using a search on a hashed PII. At block 5060, all personally identifiable information is extracted from the transaction data by processor 2100. The extracted information may be any PII as described above.

The PII is hashed by hasher 2110, block 5070, resulting in hashed PII. As discussed above, in some embodiments, a truncated portion of a card PAN may be appended or pre-pended to a piece of PII and then hashed, so that the result can only be used to link different card numbers within the same BIN.

At decision block 5080, processor 2100 attempts to match the hashed PII with an identified active account. If no account can be found, the transaction is denied, block 5110.

At decision block 5090, processor 2100 determines whether the transaction authorization request correlates to a re-occurring payment in the cancelled account. If not, the transaction is denied, block 5110.

At decision block 5100, processor 2100 determines whether the accountholder has opted into the backup payment option. If not, the transaction is denied, block 5110.

When the accountholder has opted into the backup payment option, as determined at decision block 5100, process 5000 uses the identified account for fraud detection purposes, block 5120, and the process continues at block 5050.

At block 5050, the transaction authorization request is scored using the designated profile. The scored transaction authorization request is transmitted to the issuer 1500 with the network interface 2300. In payment network embodiments that perform acquirer-side processing, the transaction score may be provided to merchant bank 1400 or merchants 1300.

It is understood by those familiar with the art that the system described herein may be implemented in hardware, firmware, or software encoded on a non-transitory computer-readable storage medium.

The previous description of the embodiments is provided to enable any person skilled in the art to practice the disclosure. The various modifications to these embodiments will be readily apparent to those skilled in the art, and the generic principles defined herein may be applied to other embodiments without the use of inventive faculty. Thus, the present disclosure is not intended to be limited to the embodiments shown herein, but is to be accorded the widest scope consistent with the principles and novel features disclosed herein.

What is claimed is:

1. A method comprising:
receiving, via a network interface, first transaction data from a merchant bank, the transaction data including a first Primary Account Number (PAN);
matching, with a processor, a first customer account in a database with the Primary Account Number;
extracting, with the processor, first personally identifiable information (PII) from the first transaction data;
hashing, with the processor, the first personally identifiable information resulting in hashed first personally identifiable information;
storing the first hashed personally identifiable information with the first customer account in the database;
receiving, via the network interface, a transaction authorization request for a financial transaction from the merchant bank, the transaction authorization request including a second Primary Account Number (PAN);
matching, with the processor, a second customer account in a database with the Primary Account Number;
when the second customer account does not have an associated second spending profile:
extracting, with the processor, second personally identifiable information (PII) from the transaction data;
hashing, with the processor, the second personally identifiable information resulting in hashed second personally identifiable information;
matching, with a processor, a first customer account in a database with the hashed second personally identifiable information, the first customer account being associated with a first spending profile;
scoring the financial transaction with the first spending profile, resulting in a transaction score; and
transmitting, with the network interface, the transaction score to an issuer of the first Primary Account Number, merchant, or merchant bank.

2. The processing method of claim 1, wherein hashing the first personally identifiable information includes either appending or prepending a first six digits of the Primary Account Number with the personally identifiable information.

3. A method of maintaining payment account continuity, the method comprising:
receiving, via a network interface, a transaction authorization request for a financial transaction from a merchant bank, the transaction authorization request including a Primary Account Number (PAN);
matching, with a processor, a first customer account in a database with the Primary Account Number;
when the first customer account does not have an associated first spending profile:
extracting, with the processor, personally identifiable information (PII) from the transaction data;
hashing, with the processor, the personally identifiable information resulting in hashed personally identifiable information;
matching, with a processor, a second customer account in a database with the hashed personally identifiable information, the second customer account being associated with a second spending profile;
scoring the financial transaction with the second spending profile, resulting in a transaction score; and
transmitting, with the network interface, the transaction score to an issuer of the Primary Account Number, merchant, or merchant bank.

4. The processing method of claim 3, wherein hashing the personally identifiable information includes either appending or prepending a first six digits of the Primary Account Number with the personally identifiable information.

5. A method of maintaining payment account continuity, the method comprising:
receiving, via a network interface, a transaction authorization request for a financial transaction from a merchant bank, the transaction authorization request including a Primary Account Number (PAN) of a cancelled customer account;
extracting, with a processor, personally identifiable information (PII) from the transaction data;
hashing, with the processor, the personally identifiable information resulting in hashed personally identifiable information;
matching, with the processor, an active customer account in a database with the hashed personally identifiable information, the active customer account being associated with an active spending profile;
scoring, with the processor, the financial transaction with the active spending profile, resulting in a transaction score; and
transmitting, with the network interface, the transaction score to an issuer of the Primary Account Number, merchant, or merchant bank.

6. The processing method of claim 5, wherein hashing the personally identifiable information includes either appending or prepending a first six digits of the Primary Account Number with the personally identifiable information.
